(19) United States
(12) Patent Application Publication
(10) Pub. No.: US 2004/0241508 A1
(43) Pub. Date: Dec. 2, 2004

(54) Fuel cell device

(76) Inventors: Gesine Arends, Gerlingen (DE); Peter Riegger, Stuttgart (DE)

Correspondence Address: STRIKER, STRIKER & STENBY, 103 East Neck Road, Huntington, NY, 11743, US

(21) Appl. No.: 10/839,098

(22) Filed: May 5, 2004

(30) Foreign Application Priority Data
May 26, 2003 (DE) 103 23 636.8

(51) Int. Cl. H01M 8/06

(52) U.S. Cl. 429/19; 429/20

(57) ABSTRACT

A fuel cell device has a reactor for a first conversion step for producing a hydrogen-enriched synthetic gas for a fuel cell from a fuel, and a at least one preparation unit for adaptation of a reformate gas to operational conditions of the fuel cell, at least one the elements selected from the group consisting of the reactor and the at least one preparation unit being composed at least partially of synthetic plastic.

### BACKGROUND OF THE INVENTION

The present invention relates to fuel cell devices.

Fuel cell devices became important in the area of the drive technology and also in other technical areas. Fuel preparation apparatuses for fuel cell devices became also known, which by means of a fuel reformer convert the fuel, for example hydrocarbon or hydrocarbon mixture, into hydrogen-containing reformate gas suitable for operation of a fuel cell.

This conversion is performed frequently in so-called steam reformers or autothermic reformers. In addition to a fuel, starting material, also water steam is required to release the hydrogen. The conventional use second process step for further conversion requires also water steam. Also, in other methods, (for example partial oxidation) as a first process step the invention for further/subsequent steps is usable.

Since the used starting material and in particular the supplied water must be very pure, a deionizing action of the process water is provided. The reformer as well as the subsequently connected structural units, such as for example reactors, heat exchangers, etc., as a rule are made of high grade steel. The manufacture of parts from high grade steel involves however relatively high production expenses.

### SUMMARY OF THE INVENTION

Accordingly, it is an object of the present invention to provide a fuel cell device, which eliminates the disadvantages of the prior art.

In particular, it is an object of the present invention to provide a fuel cell device, in particular with a gas preparation apparatus, which can be manufactured with substantially lower costs.

In keeping with these objects and with others which will become apparent hereinafter, a fuel cell device, comprising a reactor for a first conversion step for producing a hydrogen-enriched synthetic gas for a fuel cell from a fuel; and preparation means including at least one preparation unit for adaptation of a reformate gas to operational conditions of the fuel cell, at least one elements selected from the group consisting of said reactor and said at least one preparation unit being composed at least partially of synthetic plastic.

The inventive fuel cell device is characterized in that the reactor of the first conversion step and/or subsequent preparation units located after the reactor are composed at least partially of synthetic plastic. The use of synthetic plastic provides cost advantages because of election of this material.

Moreover, with suitable forming processes the processing of the synthetic plastic is considerably more favorable then of high grade steel. Also, the process or line guide can be improved in a synthetic plastic component with the greater structural possibilities.

Complex geometries and a compact layout are possible correspondingly with the inventive use of synthetic plastic. The thermal capacity of many synthetic plastics moreover is substantially lower, whereby a faster starting condition of the fuel cell device can be obtained.

Furthermore, synthetic plastics have thermal conductivity which as a rule is lower than that of metal, in particular high grade steel. This also provides the advantage that the different temperature regions during the gas preparation can be better separated. Moreover, easier process control and lower heat losses take place during the gas preparation.

The use of synthetic plastic has additionally the advantage that no ion discharge can take place in the reformate gas. Any type of charge carrier which extends into the fuel cell is damaging for the operation of the fuel cell, or in other words it worsens its power. Charge carriers in the fuel cells produce a higher resistance with the connected heat generation. In extreme case this heat generation poses a danger for the fuel cell membrane.

In a preferable embodiment of the present invention, a synthetic plastic is used with a heat conductivity greater than 10 W/mK. A certain heat conductivity is guaranteed, so that an inventive preparation unit is accessible with a temperature control, for example by cooling.

Synthetic plastic materials which can be used, for example, in accordance with the present invention includes for example PTFE, PA, PPS and/or PEEK. These synthetic plastics have a high temperature resistance. They are usable for example up to approximately 250° C., and in some cases in a higher temperature. The above mentioned synthetic plastics moreover have a high form stability and are located with their heat conductivity in the desired, above mentioned region.

In accordance with a further embodiment of the present invention, different synthetic plastics are provided for the inventive manufacture of a preparation unit. In this manner, the synthetic plastic properties can be varied depending on the locally occurring requirements. Thus, in terminal region, in which mechanical requirements are predominant a different material can be used than in regions in which other requirements, for example a higher heat transfer or the like have to be obtained.

In addition to the use of different synthetic plastics, in a special embodiment of the present invention also the local different influences of the material properties are taken into consideration by corresponding admixtures. Thus, for example the carbon content in the same basic material can be locally varied, to provide for example the thermal conductivity which is locally different. Also, the mechanical properties can be changed, for example by a different carbon content.

The preparation unit made in accordance with the present invention can be for example a reactor, which is provided for a chemical conversion of the reformate gas. Such reactors are used as purifying stages with different operational temperatures, to oxidize carbon monoxide in reformate gas to carbon dioxide, since carbon monoxide is a damaging and therefore undesirable gas for the fuel cell.

In such reactors a line guide for the reformate gas and a reaction space must be provided. Moreover, in many known apparatuses an starting material stream is guided through such purification stages, to use the reaction heat of the starting material preheating.

The forming for these structural features is characterized by a significantly greater design freedom due to the use of synthetic plastic.

In a special embodiment of the present invention, the synthetic plastic material is provided in a reactor directly as a carrier for a catalytic material. Hereby depending on the application, the use of synthetic plastic can provide advantages since geometries with greater surfaces are well formable, and can be subsequently coated catalytically. A greater surface of catalytically active material also means an improved chemical conversion in the reactor on the catalytic material.

In accordance with another embodiment of the present invention, the preparation unit is formed with the use of synthetic plastic as a heat exchanger. Heat exchangers in fuel reforming apparatuses for fuel cells are used at different locations. These heat exchangers are used to cool the temperature of the reformate gas in the course to fuel cells. The reformate gas temperatures is adapted here for example to the operational temperature of purification stages or also to the operational temperature of the fuel cell, depending on the position of the heat exchanger.

In this embodiment, a heat exchanger in such a fuel cell reforming apparatus is produced at least partially of synthetic plastic. The above mentioned advantages of the possible structural freedom as well as lowering manufacturing expenses also are obtained here.

When several preparation units, such as above mentioned reactors are provided as purification stages and heat exchangers, then the inventive use of synthetic plastic does not stay on the way. The advantages provided in accordance with the present invention are obtained even greater, the more preparation units are built correspondingly. For example, three, four or more preparation units can be utilized.

As mentioned herein above, the fluid lines for example for reformate gas or a starting material with the inventive use of synthetic plastic can be introduced during the formation process. When compared with the use of metal, this provides significant design freedom with low cost manufacture.

In accordance with special advantageous embodiment of the present invention, great numbers can be produced with cost-favorable manufacture when an inventive preparation unit is made by injection molding process. When compared with a manufacture of metal, an injection molded synthetic plastic unit has a significant cost advantage.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a diagram illustrating a fuel cell device in accordance with the present invention.

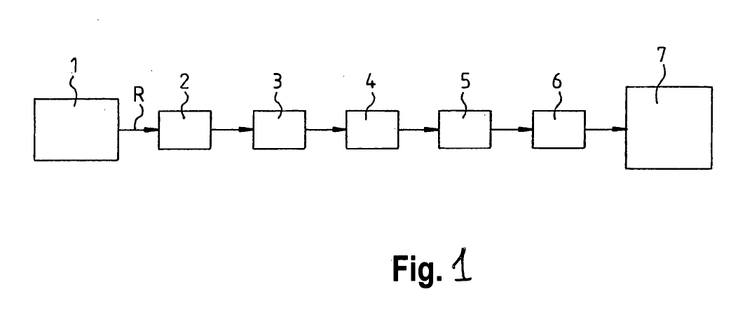

### DESCRIPTION OF THE PREFERRED EMBODIMENTS

A fuel cell device in accordance with the present invention has a fuel reformer 1 which is supplied with a starting material, for example with water and a hydrocarbon or a hydrocarbon mixture. The reformate gas stream R subsequently passes through different preparation units.

First the reformate gas is supplied to a heat exchanger 2, in which hot reformate gas is cooled to the operational temperature of a subsequent reactor 3 which serves as a purification stage. In the reactor 3 carbon monoxide with water steam is converted into carbon dioxide, and additional reaction heat is produced.

The reformate gas is subsequently supplied through a further heat exchanger 4 to a second reactor 5 which serves as a further purification stage. The reactor 5 operates at an operational temperature which is lower than in the reactor 3 and is adjusted via the heat exchanger 4.

At the lower operational temperature, less conversion of carbon monoxide into carbon dioxide takes place. However, a complete purification of carbon monoxide is possible.

At the outlet of the reactor 5 a further heat exchanger 6 is provided. It brings the reformate gas to the operational temperature of the fuel cell 7.

This arrangement corresponds to a known fuel cell device with fuel reforming. Depending on specifics, one or more starting material streams can be supplied in a counterstream to the reformate gas stream R through the heat exchanger 2, 4, 6, and/or the reactors 3, 5, so that these starting materials are preheated.

In accordance with the present invention, one or several units of the fuel reforming can be produced at least partially of synthetic plastic. Basically, the inventive advantages are provided with the use in the reformer 1, in which the problem of the high operational temperature takes place.

Known plastics, in particular the above listed plastics, are suitable to be used in the subsequent units, for example in the reactors 3, 5 or the heat exchangers 2, 4, 6.

Various possibilities of use can be provided. For example a complete use or only a partial use of synthetic plastic, combination or different plastics, or also a combination of plastics with different materials for the inventive device.

What is important is that the novelty of the present invention resides in at least partial elimination of the known use of metal and its replacement with synthetic plastic.

It will be understood that each of the elements described above, or two or more together, may also find a useful application in other types of constructions differing from the types described above.

While the invention has been illustrated and described as embodied in fuel cell device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A fuel cell device, comprising a reactor for a first conversion step for producing a hydrogen-enriched synthetic gas for a fuel cell from a fuel; and preparation means including at least one preparation unit for adaptation of a reformate gas to operational conditions of the fuel cell, at least one elements selected from the group consisting of said reactor and said at least one preparation unit being composed at least partially of synthetic plastic.

2. A fuel cell device as defined in claim 1, wherein said synthetic plastic has a thermal conductivity of greater than 10 W/mK.

3. A fuel cell device as defined in claim 3, wherein said synthetic plastic is a material selected from the group consisting of PTFE, PA, PPS, PEEK, and a combination of at least two of said materials.

4. A fuel cell device as defined in claim 1, wherein said synthetic plastic includes a combination of different synthetic plastics.

5. A fuel cell device as defined in claim 1, wherein said synthetic plastic has a regionally variable composition.

6. A fuel cell device as defined in claim 1, wherein said synthetic plastic material has a regionally variable carbon content.

7. A fuel cell device as defined in claim 1, wherein said at least one preparation unit has a reactor for a further chemical conversion of at least a part of the reformate gas.

8. A fuel cell device as defined in claim 1, wherein said synthetic plastic includes a synthetic plastic carrier and a catalytic material applied on said synthetic plastic carrier.

9. A fuel cell device as defined in claim 1, wherein said at least one preparation unit is formed as a heat exchanger for use of waste heat.

10. A fuel cell device as defined in claim 1; and further comprising at least one further preparation unit which is also at least partially composed of a synthetic plastic material.

11. A fuel cell device as defined in claim 1; and further comprising a fluid line provided for guiding at least one substance selected from the group consisting of a reformate gas and a starting material, said fluid line being formed in said at least one preparation unit.

12. A fuel cell device as defined in claim 1, wherein said at least one preparation unit is at least partially injection molded.
